(19) United States
(12) Patent Application Publication
(10) Pub. No.: US 2020/0034167 A1
(43) Pub. Date: Jan. 30, 2020

(54) AUTOMATIC APPLICATION MIGRATION ACROSS VIRTUALIZATION ENVIRONMENTS

(71) Applicant: Nutanix, Inc., San Jose, CA (US)

(72) Inventors: Ranjan PARTHASARATHY, Milpitas, CA (US); Ziv KENNAN, Sunnyvale, CA (US)

(73) Assignee: Nutanix, Inc., San Jose, CA (US)

(21) Appl. No.: 15/233,808

(22) Filed: Aug. 10, 2016

(51) Int. Cl. G06F 9/455

(52) U.S. Cl. CPC G06F 9/45558; G06F 2009/4557

(57) ABSTRACT

Systems for migrating from an application running in a virtual machine to a containerized version of the application. A method commences by identifying a computing system comprising virtual machines (VMs) that execute applications. A user or processing entity identifies a subject application to be migrated to an application container that is run in place of the VM subject application. A processing entity analyzes the subject application to determine application profile attributes and then matches at least some of the application profile attributes to one or more candidate application containers. Based on administrative rules, a particular application container image corresponding to one of the matched candidate application containers is selected and invoked so as to run in the computing system in place of the application in the virtual machine(s). The application in VMs are quiesced before the virtual machine assets are migrated. The invoked application container image uses the migrated assets.

### FIELD

This disclosure relates to hyper-converged distributed computing and storage systems, and more particularly to techniques for automatic application migration between virtual machines and containers.

### BACKGROUND

Many modern computing systems include virtual machines (VMs) to improve the utilization of computing resources. VMs can be characterized as software-based computing “machines” implemented in a virtualization environment that emulates the underlying resources (e.g., underlying CPU, memory, underlying operating system, etc.). Some of the VMs can operate on one physical machine (e.g., host computer) running a first host operating system, while other VMs might run multiple applications over various respective guest operating systems, which guest operating systems can differ from the host operating system. Virtualization flexibility can be facilitated by a hypervisor that is logically situated between the various guest operating systems of the VMs and the host operating system running on the physical infrastructure. The guest operating systems and the host operating system can each run with their own kernel—the hypervisor facilitates communications between the guest operating systems and the underlying host operating system and/or the underlying physical infrastructure.

Another form of virtualization used in modern computing systems is operating system virtualization or container virtualization. The containers implemented in container virtualization environments comprise groups of processes and/or resources (e.g., memory, CPU, disk, etc.) that are isolated from the host computer and other containers. Containers directly interface with portions of the host operating system (e.g., the host operating system kernel). In most cases of container deployment, there is no hypervisor layer. Container implementation of computing tasks is often considered to be lightweight as compared to virtual machines with a hypervisor. The lightweight aspect of containers facilitates highly efficient distribution of certain types of software components such as applications or services (e.g., micro-services). In some cases, a user (e.g., an enterprise system administrator) might deploy a hypervisor-based virtualization environment for one purpose and deploy a container environment for other purposes. For example, an enterprise might deploy some applications on VMs in a full virtualization environment while deploying other applications as containers to be run in a container virtualization environment. At some point in time the enterprise might want to move one or more applications from a hypervisor-based deployment to a container-based deployment (or vice-versa).

Unfortunately, legacy techniques for migrating between hypervisor-based virtualization and container-based virtualization environments present limitations, at least in their ability to efficiently migrate applications between virtual machines and containers. More specifically, certain legacy approaches merely remount the entire set of disks (e.g., virtual disks) comprising the VM and its applications to a container. In such cases, the lightweight partitioning aspects (e.g., portability, development efficiency, etc.) of container virtualization are not realized. In other approaches, applications and/or services from a VM can be manually migrated to a containerized form. However, the human and computing resources consumed by such manual approaches can be quite high. Further, the period of time to execute a manual migration or port can sometimes introduce periods of unavailability and/or downtime of the host system. In some legacy cases, behavior of the application is undesirably altered during the course of migration.

What is needed is a technique or techniques to improve over legacy and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for automatic application migration between virtual machines and containers, which techniques advance the relevant technologies to address technological issues with legacy approaches. More specifically, the present disclosure provides a detailed description of techniques used in systems, methods, and in computer program products for automatic application migration between virtual machines and containers. Certain embodiments are directed to technological solutions for implementing a profile-based component selection technique to automatically migrate applications between disparate virtualization environments.

The disclosed embodiments modify and improve over legacy approaches. In particular, the herein-disclosed techniques provide technical solutions that address the technical problems attendant to efficiently migrating an application between a virtual machine implementation and a container implementation. Such technical solutions serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to hyper-converged computing systems.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A1, FIG. 1A2 and FIG. 1A3 illustrates application migration techniques as implemented in systems for automatic application migration between virtual machines and containers, according to some embodiments.

FIG. 1B illustrates an application modification technique as implemented in systems for automatic application migration between virtual machines and containers, according to an embodiment.

FIG. 1C depicts an environment in which embodiments of the present disclosure can operate.

FIG. 2A presents an application component merging technique as implemented in systems for automatic application migration between virtual machines and containers, according to some embodiments.

FIG. 2B depicts implementation techniques as used when implementing automatic application migration between virtual machines and containers, according to some embodiments.

FIG. 3A presents a virtual machine application migration technique as implemented in systems for automatic application migration between virtual machines and containers, according to some embodiments.

FIG. 3B presents an application container migration technique as implemented in systems for automatic application migration between virtual machines and containers, according to some embodiments.

FIG. 4A and FIG. 4B depict system components as arrangements of computing modules that are interconnected so as to operate cooperatively to implement certain of the herein-disclosed embodiments.

FIG. 5A and FIG. 5B depict virtualized controller architectures comprising collections of interconnected components suitable for implementing embodiments of the present disclosure and/or for use in the herein-described environments.

### DETAILED DESCRIPTION

Some embodiments of the present disclosure address the problem of efficiently migrating an application between a virtual machine implementation and a container implementation. Some embodiments are directed to approaches for implementing a profile-based component selection technique to automatically migrate applications between disparate virtualization environments. The accompanying figures and discussions herein present example environments, systems, methods, and computer program products for automatic application migration between virtual machines and containers.

### Overview

Disclosed herein are techniques for implementing a profile-based component selection technique to automatically migrate applications between disparate virtualization environments. In certain embodiments, a migration module implemented in a distributed computing system can analyze the virtual machines in the distributed computing system to identify a subject application for migration to a containerized form.

As used in computing environments and contexts herein, an application (e.g., an application to be migrated) is a collection of a plurality of software instructions that are interrelated so as to carry out one or more computer processing tasks when the instructions are loaded into a memory and executed by a data and/or instruction processor. Such a collection of a plurality of software instructions can be in the form of an application that runs in one or more virtual machines, and/or can be in the form of an application container image.

An application container image can be created and/or selected based in part on the name and/or nature of the application to be migrated. Certain components (e.g., stored data) of the subject application can be integrated with the container image to create an application container. The application container can be started for access by one or more users. In certain embodiments, the subject application can be identified at least in part by determining matching characteristics and/or matching stored data (e.g., disk contents and/or virtual disk contents) from the virtual machine to one or more application profiles. In certain embodiments, the container image can be selected from a container repository. In certain embodiments, the operating system (OS) of the virtual machine hosting the subject application can be different from the operating system associated with the application container. In certain embodiments, the version of the subject application running on the virtual machine can be different from the version of the application container. In certain embodiments, an application container can be migrated to an application running on a virtual machine.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. Also, references throughout this specification to “some embodiments” or “other embodiments” refers to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments.

### Definitions

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Example Embodiments

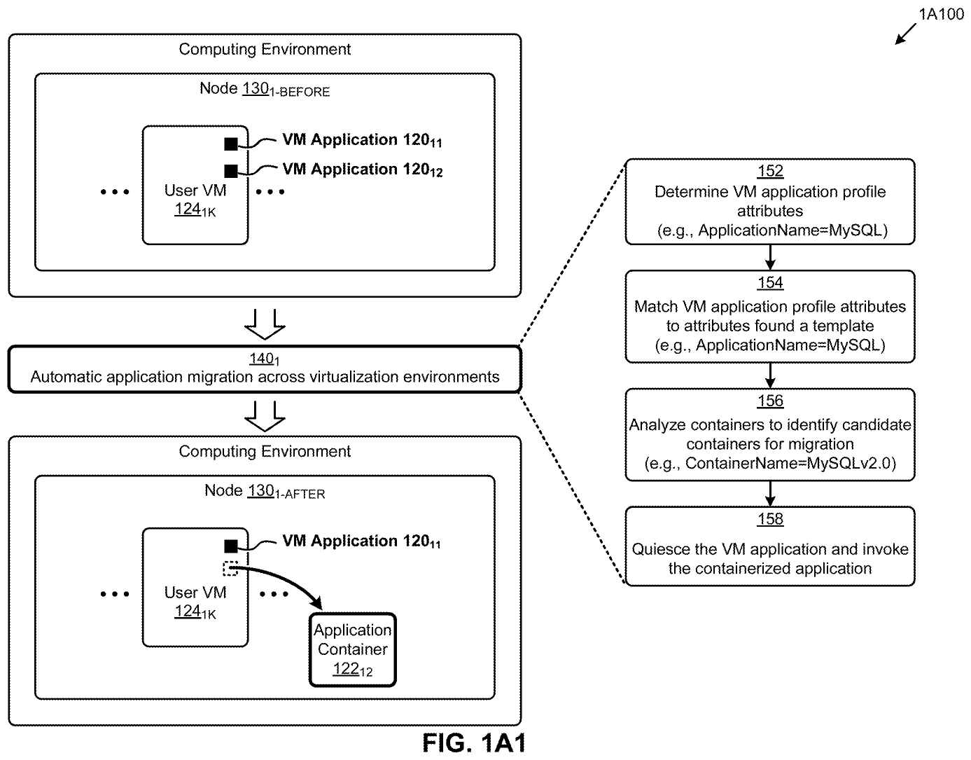

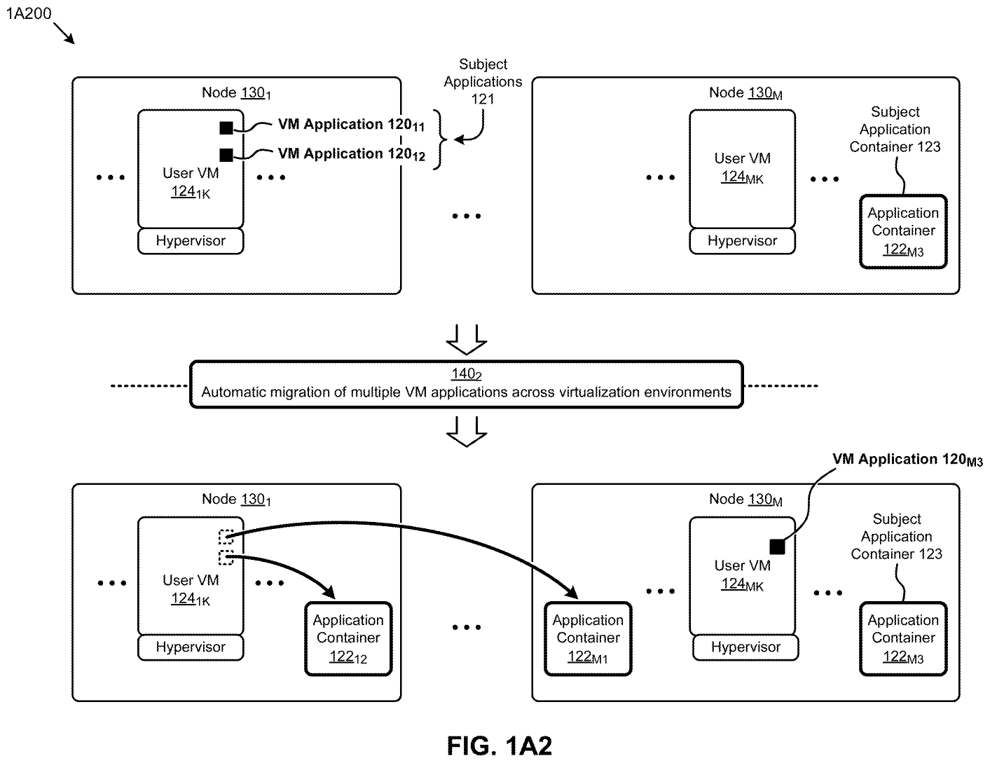

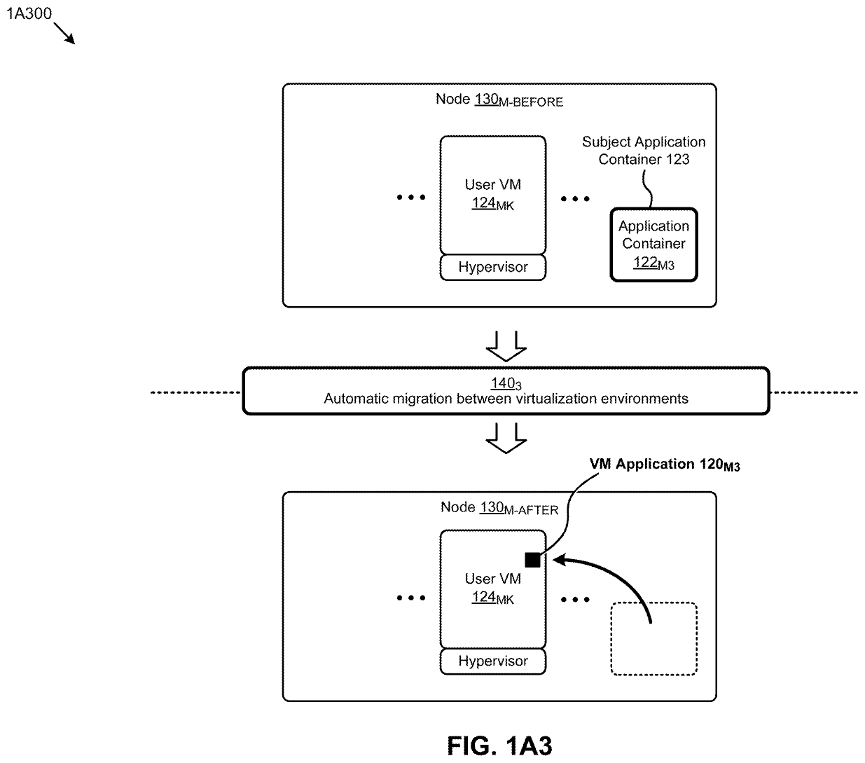

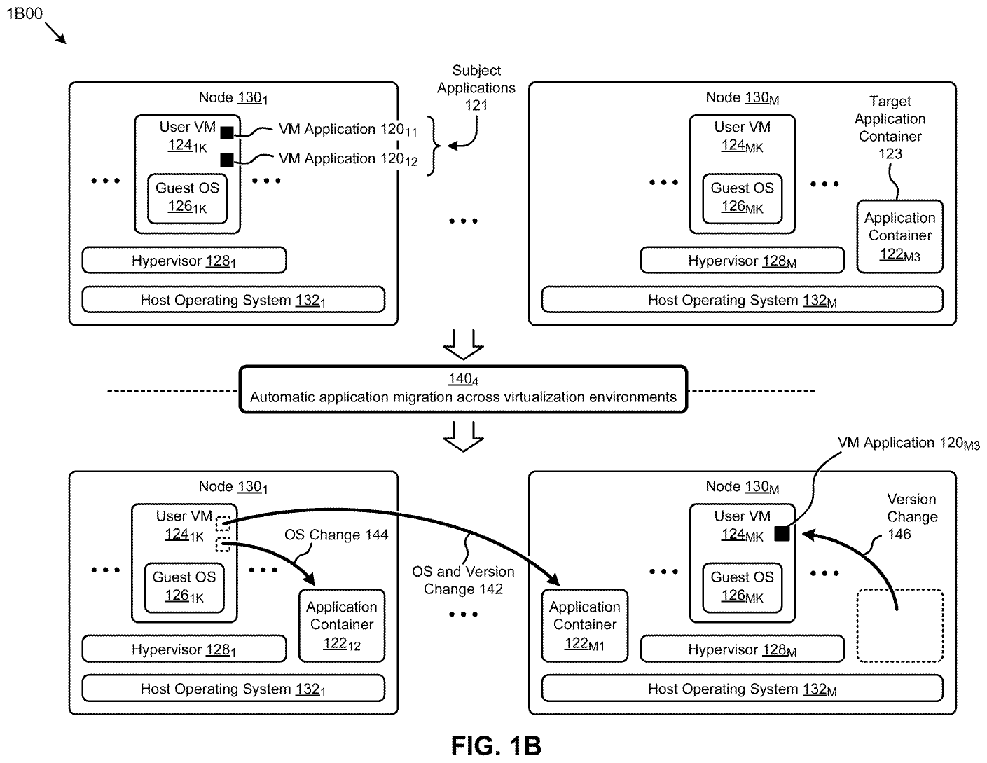

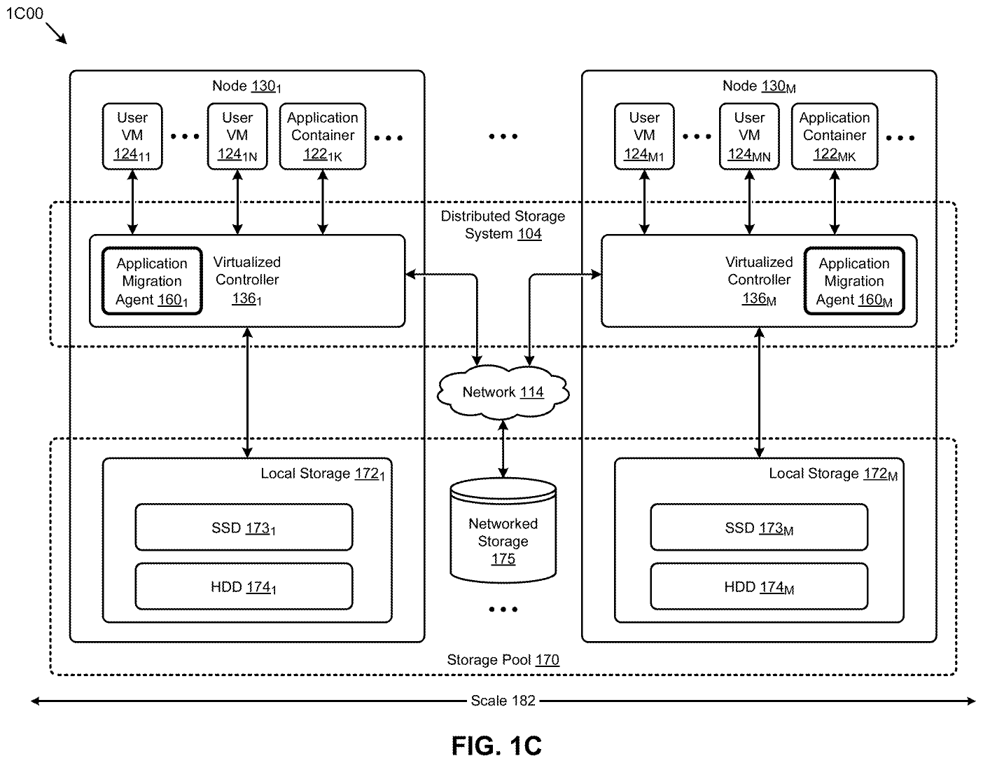

FIG. 1A1 illustrates an application migration technique 1A100 as implemented in systems for automatic application migration between virtual machines and containers. As an option, one or more variations of application migration technique 1A100 or any aspect thereof may be implemented in the context of the architecture and functionality of the embodiments described herein. The application migration technique 1A100 or any aspect thereof may be implemented in any environment.

The application migration technique 1A100 shown in FIG. 1A1 depicts a computing node 130_{1-BEFORE}. Such a node can include a hypervisor and/or other components that facilitate deployment of virtual machines. As an example, a user virtual machine (VM) such as the shown user VM 124_{1K} can be implemented in a full virtualization environment on node 130_{1-BEFORE}. As shown, VM application 120₁₁ and VM application 120₁₂ run within user VM 124_{1K}. Strictly as an example, user VM 124_{1K} might be configured to run a database management application (e.g., as VM application 120₁₁) and a content management application (e.g., as VM application 120₁₂). Using the herein-disclosed techniques, a VM application (e.g., VM application 120₁₂) can be automatically migrated (operation 140₁) from a virtual machine implementation such as is depicted in node 130_{1-BEFORE} to a containerized implementation (e.g., application container 122₁₂) such as is depicted in node 130_{1-AFTER}.

The aforementioned automatic migration of operation 140₁ can be facilitated by a series of analysis and matching steps. As shown, a series of steps includes determining a VM application to be migrated, and determining a set of VM application profile attributes such as “Application Name”=“MySQL” (step 152). Using the set of VM application profile attributes, some or all of those attributes can be used to match attributes found in a template (step 154). The template comprises container profile attributes that can be matched (e.g., exactly and completely matched or just partially and/or fuzzy matched). In the event there is sufficient matching, one or more containers might be identified. For example, for matching on “MySQL”, there might be a partial match for “MySQL-Version1.0.1”, or “MySQL-Version1.0.2”, or “MySQL-Version2.0.1”, etc. then, using any of a wide range of selection factors, a set of available containers are analyzed to identify a candidate target container (e.g., “MySQL-Version2.0.1”) to become the migrated containerized application (step 156). Once a candidate target containerized application has been identified and verified to be suitable for the migration, then the system quiesces the VM application and positions (e.g., stores) the target containerized application (step 158) in a location suitable for invocation by the node. Ownership of assets owned by the VM application is migrated to ownership by the containerized application. The containerized application is invoked using the migrated assets.

In some situations, and as shown, a single user VM can host multiple VM applications. Herein-disclosed techniques can be applied to migrate a particular VM application to a container while leaving other VM applications unmodified in its host VM. In the example of FIG. 1A1, the VM application is migrated to an application container that runs on the same node. In many computing environments, multiple nodes are arranged into a group that forms a cluster. In such multiple node settings, a VM application running on a particular node of a set of nodes in a cluster can be migrated to an application container and then deployed onto a different node of the cluster. Automatic migration involving multiple nodes within the multiple node setting is depicted in FIG. 1A2. Further, the following application migration techniques can be applied to migrate multiple VM applications to multiple containers.

FIG. 1A2 illustrates an application migration technique 1A200 as implemented in systems for automatic application migration between virtual machines and containers. As an option, one or more variations of application migration technique 1A200 or any aspect thereof may be implemented in the context of the architecture and functionality of the embodiments described herein. The application migration technique 1A200 or any aspect thereof may be implemented in any environment.

The application migration technique 1A200 shown in FIG. 1A2 depicts two representative nodes (e.g., node 130₁ and node 130_{M}) that might be included in a converged distributed computing and storage system. Such nodes can facilitate various virtualization environments. Specifically, a user virtual machine such as user VM 124_{1K} can be implemented in a hypervisor-assisted virtualization environment on node 130₁. As shown, various applications (e.g., VM application 120₁₁ and VM application 120₁₂) can be installed on user VM 124_{1K}. For example, user VM 124_{1K} might run database management applications (e.g., Redis, MySQL, etc.) and/or content management applications (e.g., WordPress). Node 130_{M} might also comprise a user VM such as user VM 124_{MK} in a hypervisor-assisted virtualization environment.

Any of the nodes can also facilitate applications implemented in an OS-assisted virtualization environment. Specifically, a containerized application (e.g., application container 122_{M3}) can be implemented in an OS-assisted virtualization environment at node 130_{M}. Virtualization in an OS-assisted virtualization environment can be supported by specific OS modules or can be supported by certain contents of a container. Some OS-assisted virtualization environments might also include a hypervisor. Some hypervisor-assisted virtualization environments might also include OS-assisted virtualization components.

In some cases, there may be conditions such that certain applications are to be migrated from one virtualization environment (e.g., a hypervisor-assisted virtualization environment) to another virtualization environment (e.g., an OS-assisted virtualization environment). As a particular example, the applications installed on user VM 124_{1K} might be selected as subject applications 121 for migration to an OS-assisted virtualization environment.

In such cases, the herein disclosed techniques can facilitate an automatic application migration across virtualization environments (operation 140₂). Specifically, according to the herein disclosed techniques, subject applications 121 comprising VM application 120₁₁ and VM application 120₁₂ can be migrated to an application container 122_{M1} and an application container 122₁₂, respectively. As shown, subject applications 121 can be migrated to another virtualization environment within a node or in another node.

Strictly as one example, when analyzing a subject application that is running on a first node (e.g., to determine its respective application profile attributes), one or more candidate target nodes can be assessed to determine if at least one of the candidate target nodes has sufficient resources to fulfill the computing demands of the migrated replacement (e.g., the migrated application container). In some cases a history pertaining to the subject application is consulted, and its resource usage (e.g., CPU usage, I/O rates, etc.) can be compared against a set of resource availabilities of a candidate target node. In other cases, a history pertaining to the candidate target node is consulted, and its resource usage can be compared to a history pertaining to the subject application.

In an opposite direction, the application container 122_{M3} might be selected as a subject application container 123 for migration to a hypervisor-assisted virtualization environment.

FIG. 1A3 illustrates an application migration technique 1A300 as implemented in systems for automatic application migration between virtual machines and containers. As an option, one or more variations of application migration technique 1A300 or any aspect thereof may be implemented in the context of the architecture and functionality of the embodiments described herein. The application migration technique 1A300 or any aspect thereof may be implemented in any environment.

As earlier mentioned, the herein disclosed techniques can further be implemented to migrate a subject application container 123 to a VM application 120_{M3} installed on user VM 124_{MK} in a hypervisor-assisted virtualization environment (operation 140₃). Such migration of application containers can be performed within a node such as depicted by node 130_{M-BEFORE} and node 130_{M-AFTER}). Migration of application containers can also be performed between different nodes.

In some cases, an application can be modified as part of the virtualization environment migration operation as shown and described as pertaining to FIG. 1B.

FIG. 1B illustrates an application modification technique 1B00 as implemented in systems for automatic application migration between virtual machines and containers. As an option, one or more variations of application modification technique 1B00 or any aspect thereof may be implemented in the context of the architecture and functionality of the embodiments described herein. The application modification technique 1B00 or any aspect thereof may be implemented in any environment.

The application modification technique 1B00 shown in FIG. 1B depicts representative nodes (e.g., node 130₁ and node 130_{M}), user VMs (e.g., user VM 124_{1K} and user VM 124_{MK}), subject applications (e.g., VM application 120₁₁ and VM application 120₁₂), and subject application container (e.g., application container 122_{M3}) earlier described in FIG. 1A1, FIG. 1A2, and FIG. 1A3. FIG. 1B further depicts an instance of a guest operating system (OS) or guest OS 126_{1K} installed on user VM 124_{1K} and a guest OS 126_{MK} installed on user VM 124_{MK}. Further, a host operating system 132₁ can be installed on node 130₁ and a host operating system 132_{M} can be installed on node 130_{M}. Also, user VM 124_{1K} might interface with an emulated instance of the hardware of node 130₁ using a hypervisor 128₁. User VM 124_{MK} can also interface with an emulated instance of the hardware of node 130_{M} using a hypervisor 128_{M}. The virtualization capabilities of the converged distributed computing and storage system represented in FIG. 1B can facilitate use of multiple operating systems at the nodes (e.g., using host operating systems) or the user VMs (e.g., using guest operating systems). For example, guest OS 126_{1K} might be a version of the Red Hat Enterprise Linux OS while host operating system 132₁ might be a version of the Microsoft Windows Server OS. As another example, guest OS 126_{MK} might be a version of the Microsoft Windows OS while host operating system 132_{M} might be a version of the CentOS OS.

When an automatic application migration across virtualization environments (operation 140₄) is performed according to the herein disclosed techniques, certain attributes pertaining to the migrated application can be changed during the process of migration. For example, when VM application 120₁₂ is migrated to application container 122₁₂, an OS change 144 can occur. Specifically, for example, VM application 120₁₂ running on a Red Hat Enterprise Linux guest OS can be migrated to application container 122₁₂ running on a Microsoft Windows Server host OS. In some cases, the operating system and the version of the application can change during the migration operation. Specifically, for example, VM application 120₁₁ can exhibit an OS and version change 142. In this case, for example, VM application 120₁₁ might be version 3.0 of Redis running on a Red Hat Enterprise Linux guest OS that is migrated to application container 122_{M1} as version 3.2 of Redis running on a CentOS host OS. Such OS, version, or other changes can also occur when migrating from an application container to a VM application. For example, the application implemented in application container 122_{M3} might be upgraded to another version (e.g., version change 146) when migrated to VM application 120_{M3}.

As earlier described, the herein disclosed techniques can be implemented in a converged distributed computing and storage system. One embodiment of an environment comprising such a distributed system is shown and described as pertains to FIG. 1C.

FIG. 1C depicts an environment 1C00 in which embodiments of the present disclosure can operate. As an option, one or more variations of environment 1C00 or any aspect thereof may be implemented in the context of the architecture and functionality of the embodiments described herein. The environment 1C00 or any aspect thereof may be implemented in any environment.

The environment 1C00 shows various components associated with one instance of a distributed storage system 104 that can be used to implement the herein disclosed techniques. Specifically, the environment 1C00 can comprise multiple nodes (e.g., node 130₁, . . . , node 130_{M}) that have multiple tiers of storage in a storage pool 170. For example, each node can be associated with one server, multiple servers, or portions of a server. A group of such nodes can be called a cluster. The multiple tiers of storage can include storage that is accessible through the network 114 such as a networked storage 175 (e.g., storage area network or SAN, network attached storage or NAS, etc.). Storage pool 170 can also comprise one or more instances of local storage (e.g., local storage 172₁, . . . , local storage 172_{M}) that is within or directly attached to a server and/or appliance associated with the nodes. Such local storage can include solid state drives (SSD 173₁, . . . , SSD 173_{M}), hard disk drives (HDD 174₁, . . . , HDD 174_{M}), and/or other storage devices.

Each node can implement at least one instance of a virtualized controller (e.g., virtualized controller 136₁, virtualized controller 136_{M}) to facilitate access to the storage pool 170 by one or more user virtual machines (e.g., user VM 124₁₁, . . . , user VM 124_{1N}, . . . , user VM 124_{M1}, . . . , user VM 124_{MN}). The hardware of the node can be emulated for the user VMs by various hypervisors. For example, such hypervisors can be implemented using virtualization software (e.g., VMware ESXi, Microsoft Hyper-V, RedHat KVM, Nutanix AHV, etc.) that includes a hypervisor. Multiple instances of such virtualized controllers can coordinate within a cluster to form a distributed storage system 104 which can, among other operations, manage aspects of storage pool 170. This architecture further facilitates efficient scaling of the distributed computing and/or storage platform (e.g., see scale 182).

As earlier described, the user VMs can run certain client software such as applications (e.g., VM applications) that might interact with the virtualized controllers to access data in the storage pool 170. Any of the nodes can also facilitate application containers (e.g., application container 122_{1K}, . . . , application container 122_{MK}) implemented in an operating system virtualization environment. Such application containers can interact with the virtualized controllers to access data in the storage pool 170.

The foregoing virtualized controllers can be implemented in environment 1C00 using various techniques. Specifically, containers (e.g., Docker containers) can be used to implement a virtualized controller at the node. In this case, the user VMs can access the storage pool 170 by interfacing with a controller container through a hypervisor and/or the kernel of the node host operating system. As another virtualized controller implementation example, an instance of a virtual machine at a given node can be used as a virtualized controller to manage storage and I/O (input/output or IO) activities. In this case, the user VMs at the node can interface with a controller virtual machine (e.g., controller VM) through a hypervisor to access the storage pool 170. In such cases, the controller VMs are not formed as part of specific implementations of the hypervisors. Instead, the controller VMs can run as virtual machines above the hypervisors on the various servers. When the controller VMs run above the hypervisors, varying virtual machine architectures and/or hypervisors can operate with the distributed storage system 104. For example, a hypervisor at one node in the distributed storage system 104 might correspond to VMware ESXi software, and a hypervisor at another node in the distributed storage system 104 might correspond to Nutanix AHV software.

In certain embodiments, one or more instances of an application migration agent can be implemented in the distributed storage system 104 to facilitate the herein disclosed techniques. Specifically, an instance of application migration agent 160₁ can be installed (at least temporarily) in virtualized controller 136₁, and another instance of application migration agent 160_{M} can be installed in the shown virtualized controller 136_{M}. Instances of the application migration agent can be implemented in any form, in any node, and in any cluster.

In some cases, the application migration agent might interact with other components in the distributed storage system 104 to discover and enumerate applications and/or to observe network activity (e.g., port scanning) and/or storage I/O activity (e.g., over named files and/or file access patterns) associated with certain virtualized applications. Specifically, the herein disclosed techniques might facilitate dynamically migrating applications among virtualization environments responsive to network performance. For example, a certain application (e.g., MySQL) might exhibit extensive use (e.g., by numerous users in a large enterprise) so as to induce application performance degradation. In such cases, the application might be automatically migrated from one virtualized environment to another virtualized environment for one or more reasons, such as to improve application performance, and/or to comply with scheduling policies (e.g., to place all container workloads on a particular connected public cloud provider), and/or to observe network or security policy changes, and/or to respond to resource availabilities due to environmental changes, and/or changes to any of a variety of compliance policy statements.

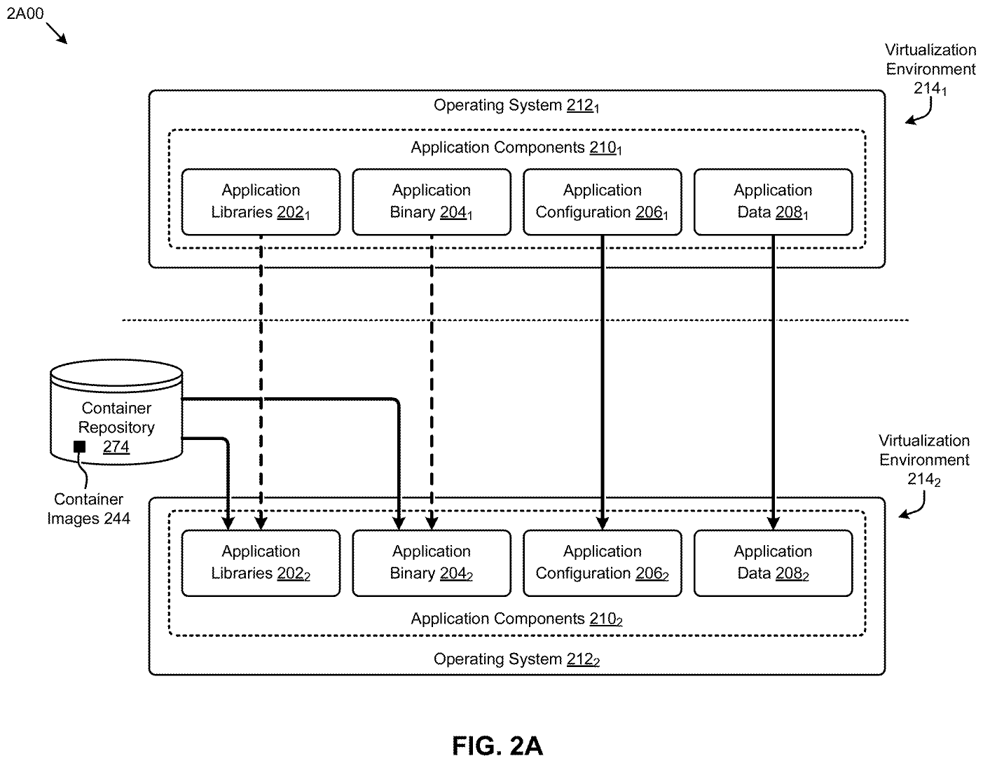

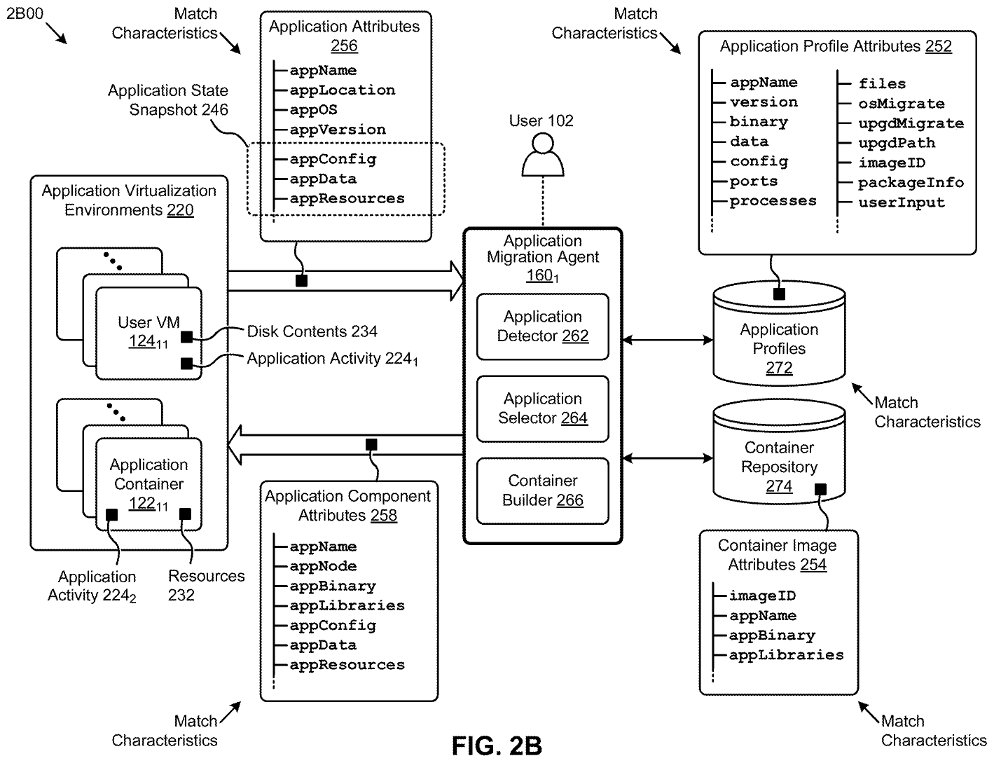

Further details regarding one implementation of the application migration agent for facilitating the herein disclosed techniques is shown and described as pertaining to FIG. 2B. One aspect of such techniques pertains to the treatment of certain components of an application targeted for migration, as shown and described in FIG. 2A.

FIG. 2A presents an application component merging technique 2A00 as implemented in systems for automatic application migration between virtual machines and containers. As an option, one or more variations of application component merging technique 2A00 or any aspect thereof may be implemented in the context of the architecture and functionality of the embodiments described herein. The application component merging technique 2A00 or any aspect thereof may be implemented in any environment.

The embodiment shown in FIG. 2A is merely one example of the treatment of various application components when migrating an application from one virtualization environment to another. Specifically, FIG. 2A depicts a set of application components 210₁ comprising an application running on a certain instance of an operating system 212₁ in a first virtualization environment (e.g., virtualization environment 214₁). As shown, application components 210₁ can comprise application libraries 202₁ (e.g., dynamic link libraries (DLLs) used by the application, etc.), application binary 204₁ (e.g., compiled application code), an application configuration 206₁ (e.g., user and/or other settings associated with the application), application data 208₁ (e.g., data used and/or generated by the application), and/or other components. When migrating the application to a second virtualization environment (e.g., virtualization environment 214₂), some of the application components 210₁ might be moved directly to the application components 210₂ in virtualization environment 214₂, while some components from another source might be used to populate application components 210₂.

For example, when migrating the application to an application container in an instance of virtualization environment 214₂ that facilitates operating system virtualization, application libraries 202₂ and/or an application binary 204₂ might be pulled from a container repository 274. Specifically, when container repository 274 has an instance of container images 244 that matches operating system 212₂ in virtualization environment 214₂, application libraries 202₂ can be derived from the container image pulled from container repository 274. In some cases, the container image might further comprise an instance of the application binary (e.g., application binary 204₂) that can also be incorporated into application components 210₂ of the migrated application. The application configuration and/or the application data can vary more among implementations as compared to the application libraries and/or the application binary. As such, the application configuration and the application data are often migrated directly from one virtualization environment to another virtualization environment. Specifically, for example, application configuration 206₁ and application data 208₁ in virtualization environment 214₁ can be migrated to application configuration 206₂ and application data 208₂, respectively, in virtualization environment 214₂. In such cases, some components from application components 210₁ and some components from container repository 274 can be merged to form application components 210₂.

One implementation of various system components and/or interactions for facilitating the foregoing application component merging technique and/or other herein disclosed techniques is shown and described as pertaining to FIG. 2B.

FIG. 2B depicts implementation techniques 2B00 as used when implementing automatic application migration between virtual machines and containers. As an option, one or more variations of implementation techniques 2B00 or any aspect thereof may be implemented in the context of the architecture and functionality of the embodiments described herein. The implementation techniques 2B00 or any aspect thereof may be implemented in any environment.

As shown in FIG. 2B, an application migration agent 160₁ as earlier described can interact with various components in a converged distributed computing and storage system to implement the herein disclosed techniques. Specifically, application migration agent 160₁ might interact with user VMs (e.g., user VM 124₁₁), application containers (e.g., application container 122₁₁), and/or other components in a collection of application virtualization environments 220 to facilitate automatic application migration between the virtualization environments (e.g., between virtual machines and containers). In some embodiments, application migration agent 160₁ can comprise an application detector 262, an application selector 264, and a container builder 266. Application detector 262 can scan application virtualization environments 220 for applications that might be candidates for migration.

For example, application detector 262 might analyze the disk contents 234 (e.g., groups of files) of user VM 124₁₁ to identify one or more candidate applications for migration. As another example, application detector 262 might analyze resources 232 (e.g., application container files, allocated container memory, etc.) of application container 122₁₁ to identify one or more candidate applications for migration. In some cases, application detector 262 can identify candidate applications by comparing (e.g., mapping) the disk contents 234 and/or the resources 232 to stored instances of application profiles 272.

A candidate application can be identified by a match or near match to one or more of application profile attributes 252 characterizing a given application profile. An application profile is a machine-readable set of application characteristics. Application characteristics are formed by pairs of attributes and respective values, any of which can be compared to attributes and attribute values found in a template.

As shown, application profile attributes 252 can comprise certain attributes corresponding to a certain application represented by an application name or appName such as an application version scope (e.g., version 1.0 to version 2.2) or version, one or more application binary identifiers (e.g., binary version, name, paths, signatures, etc.) represented by binary, one or more application data identifiers (e.g., data version, name, paths, etc.) represented by data, one or more application configuration identifiers (e.g., configuration version, name, paths, etc.) represented by contig, one or more application port signatures represented by ports, one or more application processes represented by processes, one or more application files represented by files, one or more operating system migration directives represented by osMigrate, one or more version upgrade directives represented by upgdMigrate, an upgrade path or upgdPath, a container image identifier (e.g., from container repository 274) or imageID, one or more package information attributes represented by package Info, one or more user constraints represented by userinput, and/or other attributes. An example application profile implemented according to the herein disclosed techniques is shown in Table 1.

TABLE 1
Example application profile

| Line | Profile Information |
|---|---|
| 1 | { |
| 2 | name: Redis DB |
| 3 | versions: 1.*-4.* |
| 4 | binary_profiles: |
| 5 | [{ |
| 6 | version: 1 |
| 7 | component_names: [‘redis-server’] |
| 8 | component_paths: [‘/usr/bin’, ‘/usr/local/bin’] |
| 9 | signatures: [‘964fd995801e16b4c76295b21ea591d1’] |
| 10 | }, |
| 11 | { |
| 12 | version: 2.*-4.* |
| 13 | component_names: [‘redis-server’] |
| 14 | component_paths: [‘/usr/bin’] |
| 15 | } |
| 16 | ] |
| 17 | data_profiles: |
| 18 | [{ |
| 19 | version: 1.*-4.* |
| 20 | components: [‘redis.rdb’, ‘data.rdb’] |
| 21 | component_paths: [‘/usr/local/redis’] |
| 22 | }] |
| 23 | config_profiles: |
| 24 | [{ |
| 25 | version: 1.*-4.* |
| 26 | components: [‘redis.conf’] |
| 27 | read_paths_from_runtime: true |
| 28 | }] |
| 29 | ports_signature: |
| 30 | { |
| 31 | read_ports_from_runtime: true |
| 32 | config_based: true |
| 33 | config_match_pattern: *port* |
| 34 | } |
| 35 | supports_cross_os_migration: true |
| 36 | supports_upgrade_migration: true |
| 37 | upgrade_migration_paths: [‘1.*-3.0, 3.1.*-4.*’] |
| 38 | docker_image_name: redis_[{version}] |
| 39 | package_management_signatures: [‘redis_db*’, ‘redis*’] |
| 40 | } |

When one or more candidate applications are identified in application virtualization environments 220, application selector 264 can select one or more subject applications for migration from the identified candidate applications. For example, application selector 264 might analyze the candidate applications to identify the applications that have a corresponding application image (e.g., imageID) stored in container repository 274. Container repositories such as container repository 274 can be populated internally to an enterprise and/or externally to the enterprise (e.g., an open community repository). The container images stored in container repository 274 can be characterized by a set of container image attributes 254 such as a container image identifier or imageID, an application name or appName, an application binary component identifier or appBinary, one or more application library dependencies represented by appLibraries, and/or other attributes.

As another example, application selector 264 might select certain subject applications for migration based at least in part on an enumerated list of files (e.g., based on filenames), and/or components (e.g., based on component names), and/or a set of constraints (e.g., userinput) derived from application profile attributes 252 (e.g., as may be provided by a user 102 such as a system administrator. For example, the system administrator might specify certain locations (e.g., nodes) that applications can be migrated to and/or from. The system administrator might further specify certain applications that can or cannot be selected for migration.

The application selector 264 of the application migration agent 160₁ can further facilitate collecting various information from the subject applications selected for migration from one virtualization environment to another virtualization environment. According to certain embodiments, such information can be represented by a set of application attributes 256. Specifically, application attributes 256 can comprise various attributes characterizing a given application such as an application name or appName, one or more application location attributes (e.g., node IP address, cluster ID, virtual machine ID, etc.) represented by appLocation, an application OS identifier or appos, an application version identifier or appVersion, one or more application configuration identifiers (e.g., configuration version, name, path, etc.) represented by appConfig, one or more application data identifiers (e.g., data version, name, paths, etc.) represented by appData, one or more application resource identifiers (e.g., application container files, etc.) represented by appResources, and/or other attributes.

As earlier mentioned, the application configuration and/or the application data can be highly dynamic such that a quiescing of application activity (e.g., application activity 224₁ and/or application activity 224₂) might be implemented to facilitate an automatic migration of a given subject application. In such cases, an application state snapshot 246 comprising an instance of the application configuration and/or an instance of the application data and/or an instance of the application resources (e.g., pertaining to an application container) might be captured to include in the migrated application components.

Specifically, container builder 266 might merge the application configuration and the application data comprising application state snapshot 246 with the application binary and application library components of a container image from container repository 274 to create an application container from a VM application. In some cases, container builder 266 can generate the container image. When migrating from an application container to a VM application, application migration agent 160₁ might merely install a snapshot of the resources (e.g., resources 232) from the application container (e.g., application container 122₁₁) onto one or more user VMs in a full virtualization environment.

As shown in FIG. 2B, according to some embodiments, the application components that can be used to facilitate automatic application migration can be represented by a set of application component attributes 258. Specifically, application component attributes 258 can comprise various attributes characterizing a set of application components such as an application name or appName, one or more application location attributes (e.g., node IP address, cluster ID, virtual machine ID, etc.) represented by appNode, an application binary component identifier or appBinary, one or more application library dependencies represented by appLibraries, one or more application configuration identifiers (e.g., configuration version, name, path, etc.) represented by appConfig, one or more application data identifiers (e.g., data version, name, paths, etc.) represented by appData, one or more application resource identifiers (e.g., application container files, etc.) represented by appResources, and/or other attributes.

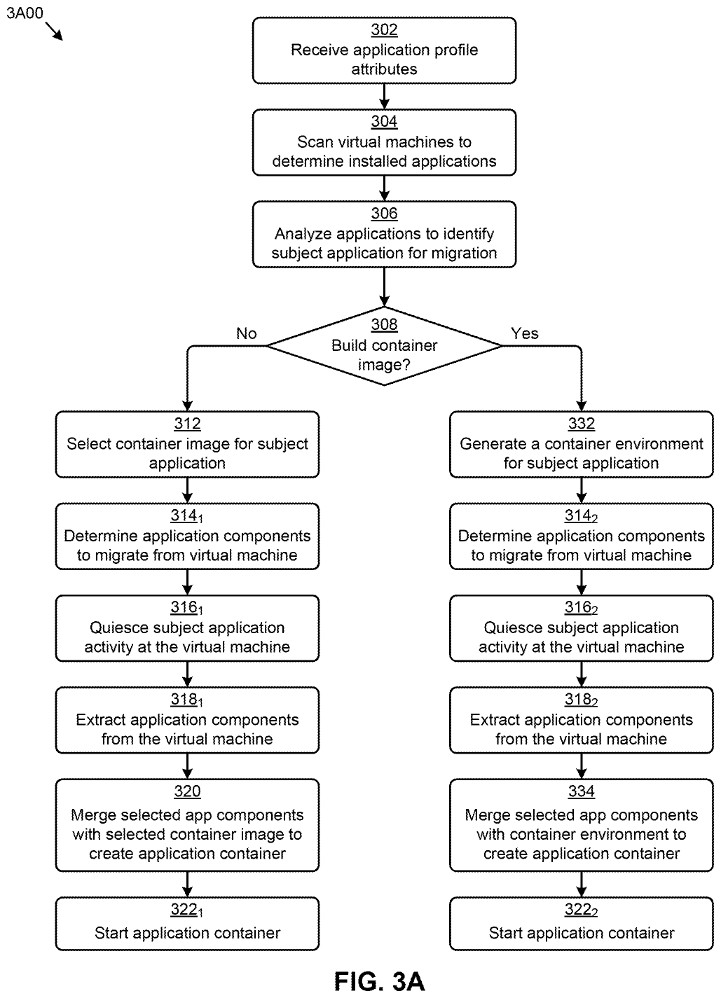

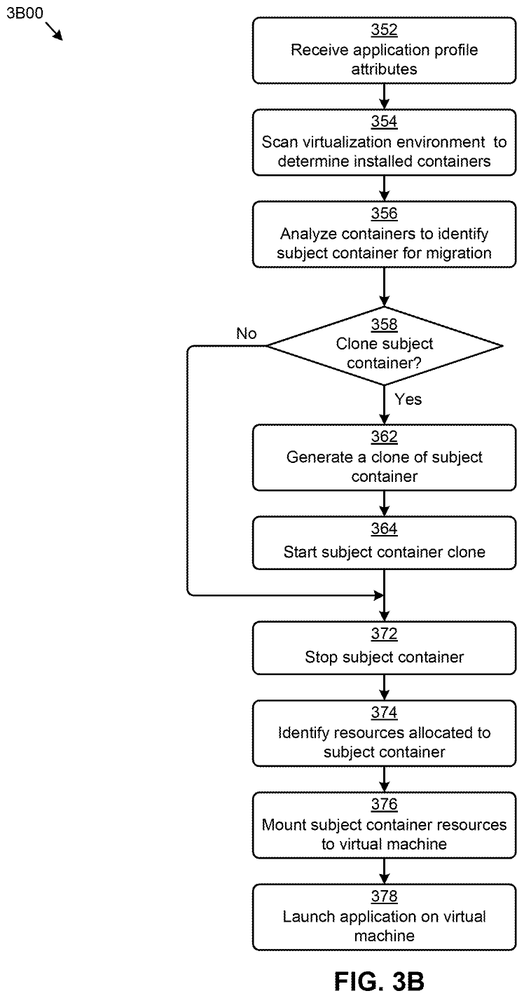

As earlier described, application migration agent 160₁ and/or techniques disclosed herein can facilitate automatic application migration from a full virtualization environment (e.g., from a virtual machine) to an operating system virtualization environment (e.g., to an application container), or from an operating system virtualization environment (e.g., to an application container) to a full virtualization environment (e.g., from a virtual machine). A technique for migrating from a full virtualization environment (e.g., from a virtual machine) is shown and described as pertaining to FIG. 3A.

FIG. 3A presents a virtual machine application migration technique 3A00 as implemented in systems for automatic application migration between virtual machines and containers. As an option, one or more variations of virtual machine application migration technique 3A00 or any aspect thereof may be implemented in the context of the architecture and functionality of the embodiments described herein. The virtual machine application migration technique 3A00 or any aspect thereof may be implemented in any environment.

The virtual machine application migration technique 3A00 presents one embodiment of certain steps and/or operations for facilitating automatic application migration from virtual machines to containers according to the herein disclosed techniques. In one or more embodiments, the steps and underlying operations comprising virtual machine application migration technique 3A00 can be executed by an instance of the application migration agent 160₁ as shown and described in FIG. 2B and herein.

As shown, virtual machine application migration technique 3A00 can receive application profile attributes (at step 302). One or more virtual machines in a full virtualization environment can be scanned to determine installed applications (at step 304). For example, the attributes of various application profiles can be used to identify the installed applications. The installed applications (e.g., candidate applications) can be analyzed to identify one or more subject applications for migration to containerized applications in an operating system virtualization environment (at step 306). A set of candidate applications can be formed from a set of installed applications that are of “known types”, such as applications for which there is a validated registration of the application at a Docker repository (or other container repository).

In some cases, a container image corresponding to the subject application might be available (see “No” path of decision 308). For example, a container image corresponding to the subject application might be available from a container repository. In some cases, the version and/or the operating system of the container image might be different from the version and/or operating system, respectively, of the subject application as implemented in the virtual machine. The container image having the desired version and operating system can be selected for the subject application (at step 312). Based on the container image selected and/or other information, any application components to be migrated from the source environment can be selected (at step 314₁). For example, the container image might include the application binaries and application library dependencies such that the application configuration and the application data can be pulled from the virtual machine of the subject application. To facilitate migration of the application components from the virtual machine, the activity of the subject application on the virtual machine can be quiesced (at step 316₁). When the application activity is quiesced, the application components can be extracted (at step 318₁).

Further details regarding general approaches to quiescing virtual machines are described in U.S. application Ser. No. 15/178,504 titled, “SAVING AND RESTORING STORAGE DEVICES USING APPLICATION-CONSISTENT SNAPSHOTS” filed on Jun. 9, 2016, (Attorney Docket No. Nutanix-061) which is hereby incorporated by reference in its entirety.

For example, an application state snapshot comprising the then-current instance of the application configuration and the then-current instance of the application data can be captured and extracted. The selected application components can be merged with the selected container image to create an application container (at step 320). The new instance of the application container can then be started (at step 322₁).

When no container image corresponding to the subject application is available (see “Yes” path of decision 308), a container environment for the subject application can be generated (at step 332). Based on the container environment generated and/or other information, any application components to be migrated from the source environment can be selected (at step 314₂). For example, the container environment might include the application binaries and application library dependencies such that the application configuration and the application data can be pulled from the virtual machine of the subject application.

Further details regarding general approaches to generating a container environment are described in U.S. application Ser. No. 15/173,577 titled, “ARCHITECTURE FOR MANAGING I/O AND STORAGE FOR A VIRTUALIZATION ENVIRONMENT USING EXECUTABLE CONTAINERS AND VIRTUAL MACHINES” filed on Jun. 3, 2016, (Attorney Docket No. Nutanix-053) which is hereby incorporated by reference in its entirety.

To facilitate migration of the application components from the virtual machine, the activity of the subject application on the virtual machine can be quiesced (at step 316₂). When the application activity is quiesced, the application components can be extracted (at step 318₂). For example, an application state snapshot comprising the then-current instance of the application configuration and the then-current instance of the application data can be captured and extracted. The selected application components can be merged with the generated container environment to create an application container (at step 334). The new instance of the application container can then be started (at step 322₂).

A technique for migrating a subject application from an operating system virtualization environment (e.g., from an application container) is shown and described as pertaining to FIG. 3B.

FIG. 3B presents an application container migration technique 3B00 as implemented in systems for automatic application migration between virtual machines and containers. As an option, one or more variations of application container migration technique 3B00 or any aspect thereof may be implemented in the context of the architecture and functionality of the embodiments described herein. The application container migration technique 3B00 or any aspect thereof may be implemented in any environment.

The application container migration technique 3B00 presents one embodiment of certain steps and/or operations for facilitating automatic application migration from containers to virtual machines according to the herein disclosed techniques. In one or more embodiments, the steps and underlying operations comprising application container migration technique 3B00 can be executed by an instance of the application migration agent 160₁ as shown and described in FIG. 2B and herein.

As shown, application container migration technique 3B00 can receive application profile attributes (at step 352). One or more installed containers in an operating system virtualization environment can be scanned to determine the applications associated with the containers (at step 354). For example, the attributes of various application profiles can be used to identify the containerized applications. The identified applications (e.g., candidate applications) can be analyzed to determine one or more subject applications for migration to one or more virtual machines in a full virtualization environment (at step 356).

In some cases, the subject application container can be cloned to facilitate a migration that is transparent to the users of the application (see “Yes” path of decision 358). In such cases, a clone of the subject container can be generated (at step 362) and started (at step 364). When the subject application container is not cloned (see “No” path of decision 358), step 362 and step 364 can be bypassed. When the subject application container is selected and a clone is generated, the application container migration technique 3B00 may stop the subject application container (at step 372). The steps corresponding to the shown step 372 and the shown step 364 might be further subdivided into coordinated steps so as to enhance user transparency that a clone has been invoked.

In some cases, the clone might be a different version of the same application that is in use by users of the application. The resources (e.g., files, data, images, libraries, etc.) allocated to the subject application container can be identified (at step 374). In some cases the identified resources might be compatible with one or more different versions. The identified resources can be mounted to one or more virtual machines in the full virtualization environment (at step 376). The migrated application can then be launched at each respective virtual machine (at step 378).

### Additional Embodiments of the Disclosure

### Additional Practical Application Examples

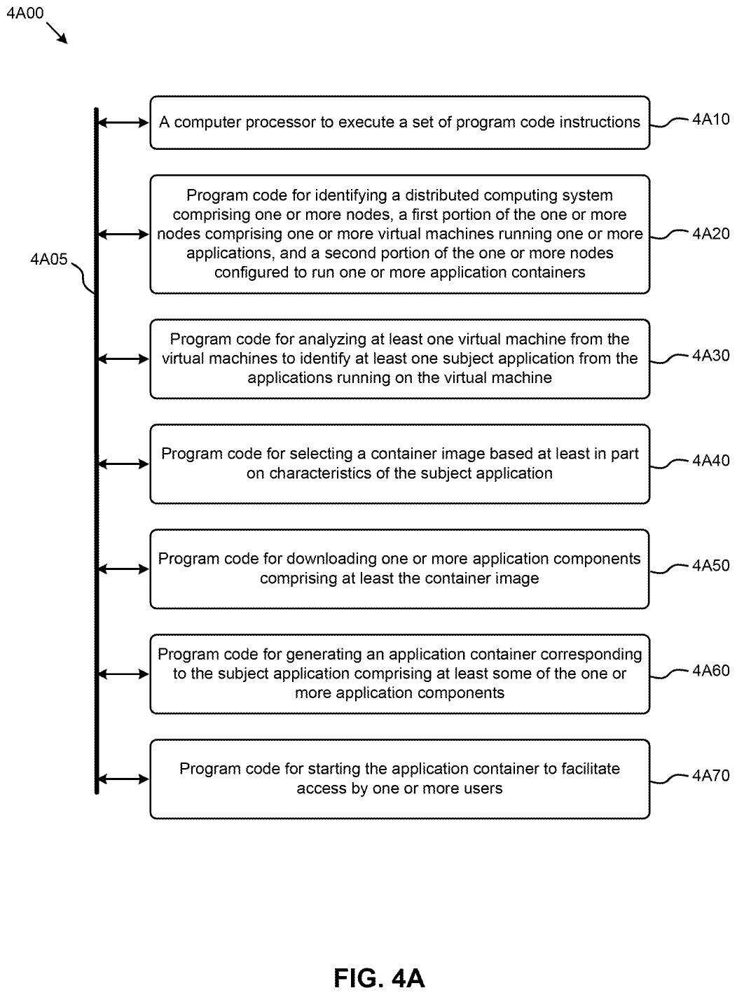

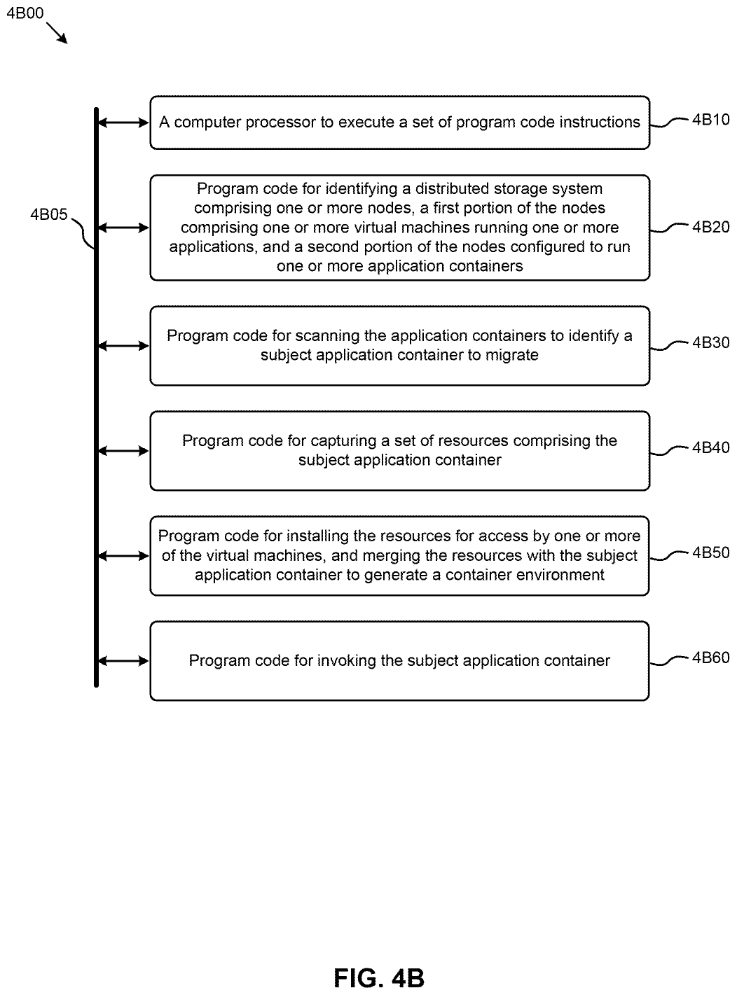

FIG. 4A depicts a system 4A00 as an arrangement of computing modules that are interconnected so as to operate cooperatively to implement certain of the herein-disclosed embodiments. The partitioning of system 4A00 is merely illustrative and other partitions are possible. As an option, the system 4A00 may be implemented in the context of the architecture and functionality of the embodiments described herein. Of course, however, the system 4A00 or any operation therein may be carried out in any desired environment.

The system 4A00 comprises at least one processor and at least one memory, the memory serving to store program instructions corresponding to the operations of the system. As shown, an operation can be implemented in whole or in part using program instructions accessible by a module. The modules are connected to a communication path 4A05, and any operation can communicate with other operations over communication path 4A05. The modules of the system can, individually or in combination, perform method operations within system 4A00. Any operations performed within system 4A00 may be performed in any order unless as may be specified in the claims.

The shown embodiment implements a portion of a computer system, presented as system 4A00, comprising a computer processor to execute a set of program code instructions (module 4A10) and modules for accessing memory to hold program code instructions to perform: identifying a distributed computing system comprising one or more nodes, a first portion of the one or more nodes comprising one or more virtual machines running one or more applications, and a second portion of the one or more nodes configured to run one or more application containers (module 4A20); analyzing at least one virtual machine from the virtual machines to identify at least one subject application from the applications running on the virtual machine (module 4A30); selecting a container image based at least in part on characteristics of the subject application (module 4A40); downloading one or more application components comprising at least the container image (module 4A50); generating an application container corresponding to the subject application comprising at least some of the one or more application components (module 4A60); and starting the application container to facilitate access by one or more users (module 4A70).

Variations of the foregoing may include more or fewer of the shown modules and variations may perform more or fewer (or different) steps, and/or may use data elements in more, or in fewer (or different) operations.

Some embodiments include variations where analyzing the virtual machine further comprises matching a set of disk content from the virtual machine to one or more application profiles.

Some embodiments include variations where the application profiles are characterized by at least one of, an application name, an application version scope, one or more application binary identifiers, one or more application data identifiers, one or more application configuration identifiers, one or more application port signatures, one or more application processes, one or more application files, one or more operating system migration directives, one or more version upgrade directives, an upgrade path, a container image identifier, one or more package information attributes, or one or more user constraints.

Some embodiments include variations where the application components comprise at least one of, an application binary, a set of application data, an application configuration component, or a set of application libraries.

Some embodiments include variations where the container image is selected from a container repository.

Some embodiments include variations where a guest operating system corresponding to the virtual machine is different from a host operating system corresponding to the container image.

Some embodiments include variations where the subject application corresponds to a first application version and the application container corresponds to a second application version.

Some embodiments include variations that further comprise (1) quiescing application activity that is associated with the subject application, (2) generating an application state snapshot of the subject application, and (3) exposing the application state snapshot to one or more of the application components.

FIG. 4B depicts a system 4B00 as an arrangement of computing modules that are interconnected so as to operate cooperatively to implement certain of the herein-disclosed embodiments. The partitioning of system 4B00 is merely illustrative and other partitions are possible. As an option, the system 4B00 may be implemented in the context of the architecture and functionality of the embodiments described herein. Of course, however, the system 4B00 or any operation therein may be carried out in any desired environment.

The system 4B00 comprises at least one processor and at least one memory, the memory serving to store program instructions corresponding to the operations of the system. As shown, an operation can be implemented in whole or in part using program instructions accessible by a module. The modules are connected to a communication path 4B05, and any operation can communicate with other operations over communication path 4B05. The modules of the system can, individually or in combination, perform method operations within system 4B00. Any operations performed within system 4B00 may be performed in any order unless as may be specified in the claims.

The shown embodiment implements a portion of a computer system, presented as system 4B00, comprising a computer processor to execute a set of program code instructions (module 4B10) and modules for accessing memory to hold program code instructions to perform: identifying a distributed storage system comprising one or more nodes, a first portion of the nodes comprising one or more virtual machines running one or more applications, and a second portion of the nodes configured to run one or more application containers (module 4B20); scanning the application containers to identify a subject application container to migrate (module 4B30); capturing a set of resources comprising the subject application container (module 4B40); installing the resources for access by one or more of the virtual machines, and merging the resources with the subject application container to generate a container environment (module 4B50); and invoking the subject application container in the one or more of the virtual machines (module 4B60).

### SYSTEM ARCHITECTURE OVERVIEW

### Additional System Architecture Examples

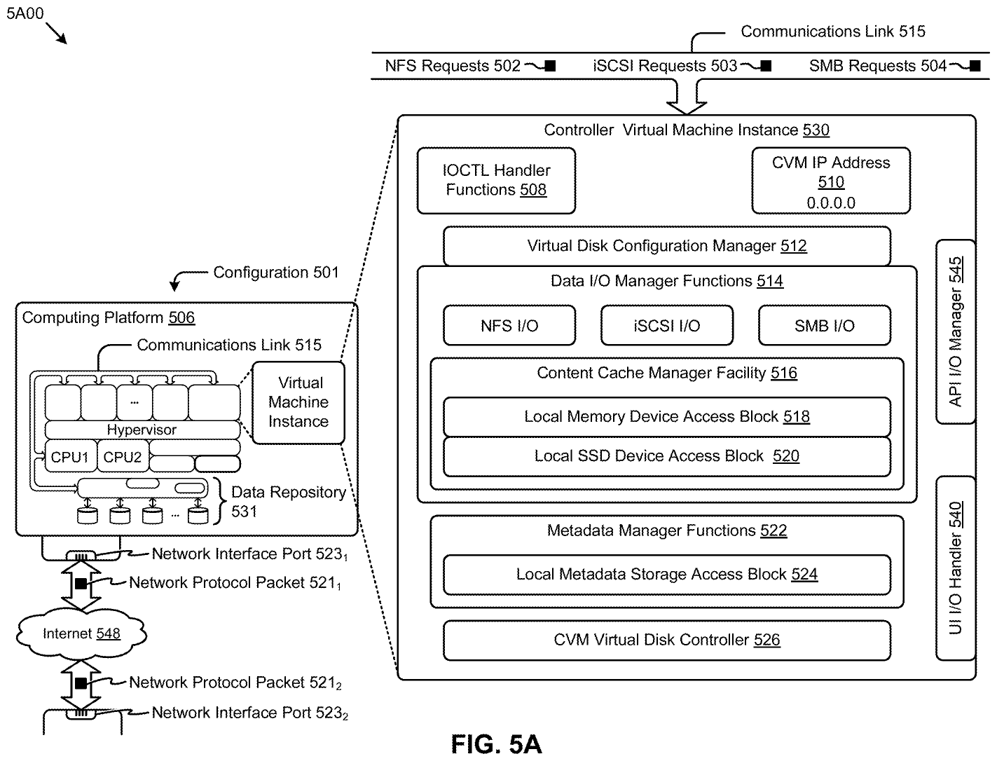

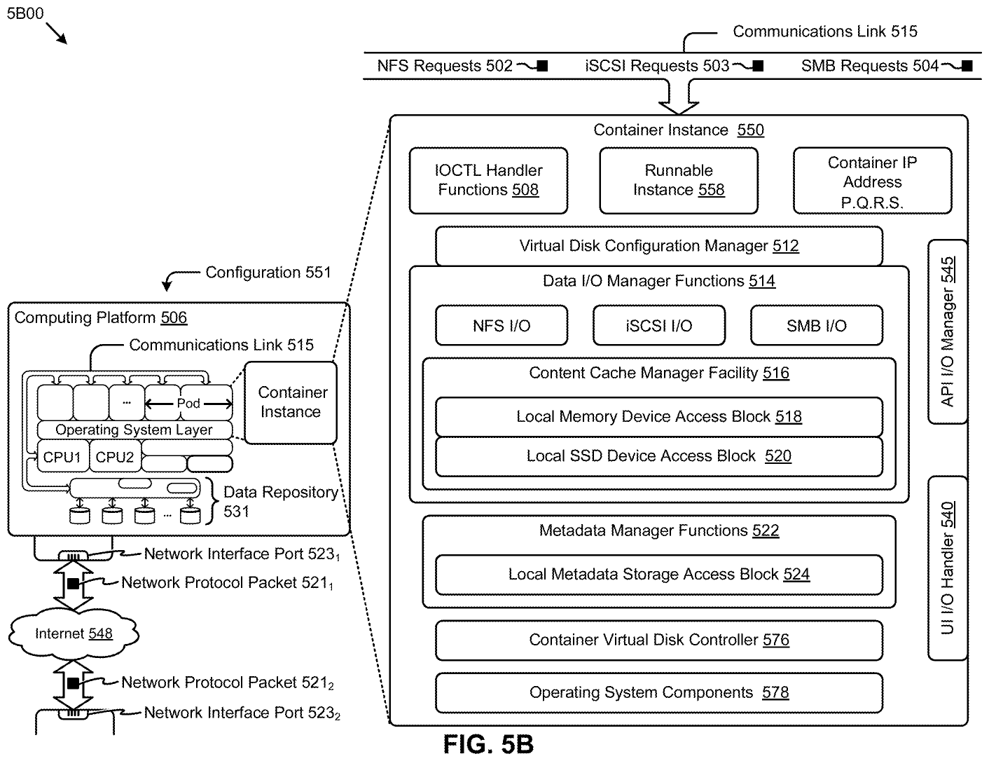

FIG. 5A depicts a virtualized controller as implemented by the shown virtual machine architecture 5A00. The virtual machine architecture comprises a collection of interconnected components suitable for implementing embodiments of the present disclosure and/or for use in the herein-described environments. Moreover, the shown virtual machine architecture 5A00 includes a virtual machine instance in a configuration 501 that is further described as pertaining to the controller virtual machine instance 530. A controller virtual machine instance receives block I/O (input/output or IO) storage requests as network file system (NFS) requests in the form of NFS requests 502, and/or internet small computer storage interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., see CVM IP address 510). Various forms of input and output (I/O or IO) can be handled by one or more IO control handler functions (see IOCTL functions 508) that interface to other functions such as data IO manager functions 514 and/or metadata manager functions 522. As shown, the data IO manager functions can include communication with a virtual disk configuration manager 512 and/or can include direct or indirect communication with any of various block IO functions (e.g., NFS IO, iSCSI IO, SMB IO, etc.).

In addition to block IO functions, the configuration 501 supports IO of any form (e.g., block TO, streaming TO, packet-based TO, HTTP traffic, etc.) through either or both of a user interface (UI) handler such as UI IO handler 540 and/or through any of a range of application programming interfaces (APIs), possibly through the shown API IO manager 545.

The communications link 515 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 530 includes a content cache manager facility 516 that accesses storage locations, possibly including local dynamic random access memory (DRAM) (e.g., through the local memory device access block 518) and/or possibly including accesses to local solid state storage (e.g., through local SSD device access block 520).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 531, which in turn can be formatted into any one or more storage areas, and which can comprise parameterized storage accessible by a key (e.g., a filename, a table name, a block address, an offset address, etc.). An external data repository 531 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 524. The external data repository 531 can be configured using a CVM virtual disk controller 526, which can in turn manage any number or any configuration of virtual disks.

Execution of the sequences of instructions to practice certain embodiments of the disclosure are performed by a one or more instances of a processing element such as a data processor, or such as a central processing unit (e.g., CPU1, CPU2). According to certain embodiments of the disclosure, two or more instances of a configuration 501 can be coupled by a communications link 515 (e.g., backplane, LAN, PTSN, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 523₁ and network interface port 523₂). The configuration 501 can be addressed through one or more network interface ports using an IP address. Any operational element within computing platform 506 can perform sending and receiving operations using any of a range of network protocols, possibly including network protocols that send and receive packets (e.g., see network protocol packet 521₁ and network protocol packet 521₂).

The computing platform 506 may transmit and receive messages that can be composed of configuration data, and/or any other forms of data and/or instructions organized into a data structure (e.g., communications packets). In some cases, the data structure includes program code instructions (e.g., application code) communicated through Internet 548 and/or through any one or more instances of communications link 515. Received program code may be processed and/or executed by a CPU as it is received and/or program code may be stored in any volatile or non-volatile storage for later execution. Program code can be transmitted via an upload (e.g., an upload from an access device over the Internet 548 to computing platform 506). Further, program code and/or results of executing program code can be delivered to a particular user via a download (e.g., a download from the computing platform 506 over the Internet 548 to an access device).

The configuration 501 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor. Some embodiments include one or more special-purpose hardware components (e.g., power control, logic, sensors, transducers, etc.). A module may include one or more state machines and/or combinational logic used to implement or facilitate the operational and/or other characteristics of performing automatic application migration between virtual machines and containers.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of performing automatic application migration between virtual machines and containers). Such files or records can be brought into and/or stored in volatile or non-volatile memory.

FIG. 5B depicts a virtualized controller implemented by a containerized architecture 5B00. The containerized architecture comprises a collection of interconnected components suitable for implementing embodiments of the present disclosure and/or for use in the herein-described environments. Moreover, the shown containerized architecture 5B00 includes a container instance in a configuration 551 that is further described as pertaining to the container instance 550. The configuration 551 includes a daemon (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The daemon can perform port forwarding to any container (e.g., container instance 550). A container instance can be executed by a processor. Runnable portions of a container instance sometimes derive from a container image, which in turn might include all, or portions of any of, a Java archive repository (JAR) and/or its contents, a script or scripts and/or a directory of scripts, a virtual machine configuration, and may include any dependencies therefrom. In some cases a virtual machine configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container (e.g., a Docker container) can be rooted in a directory system, and can be accessed by file system commands (e.g., “ls” or “ls -a”, etc.). The container might optionally include an operating system 578, however such an operating system need not be provided. Instead, a container can include a runnable instance 558, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 576. Such a container virtual disk controller can perform any of the functions that the aforementioned CVM virtual disk controller 526 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method comprising:
identifying a computing system comprising a virtual machine that executes an application;
identifying the application to be migrated to an application container;
selecting an application container image corresponding to the application from the virtual machine; and
invoking the application container image to run in the computing system in place of the application in the virtual machine, wherein the application is changed from a first version to a second version to run in the application container image.

2. The method of claim 1, further comprising:
analyzing the application to determine an application profile attribute,
matching the application profile attribute to a candidate application container, and
determining, from the application profile attribute, one or more application components.

3. The method of claim 2, wherein the one or more application components comprise at least one of, an application library, or an application configuration, or a virtual disk.

4. The method of claim 3, wherein analyzing the application further comprises matching a disk content from the virtual disk to an application profile.

5. The method of claim 4, wherein the application profile is characterized by at least one of, an application name, an application version scope, or one or more application binary identifiers, or one or more application data identifiers, or one or more application configuration identifiers, or one or more application port signatures, or one or more application processes, or a one or more application files, or any combinations therefrom.

6. The method of claim 4, wherein the matching is performed using, an operating system migration directive, or a version upgrade directive, or an upgrade path, or a container image identifier, or a package information attribute, or a user constraint or any combinations therefrom.

7. The method of claim 1, wherein the application container image is selected from a container repository.

8. The method of claim 1, wherein a guest operating system corresponding to the virtual machine is different from a host operating system corresponding to the application container image.

9. The method of claim 1, further comprising migrating the application container image from the application container to a target virtual machine.

10. The method of claim 1, further comprising:
quiescing at least a portion of application activity associated with the application; and
generating, responsive to quiescing the application activity, an application state snapshot of the application.

11. A computer readable medium, embodied in a non-transitory computer readable medium, the non-transitory computer readable medium having stored thereon a sequence of instructions which, when stored in memory and executed by one or more processors causes the one or more processors to perform a set of acts, the set of acts comprising:
identifying a computing system comprising a virtual machine that executes an application;
identifying the application to be migrated to an application container;
selecting an application container image corresponding to the application from the virtual machine; and
invoking the application container image to run in the computing system in place of the application in the virtual machine, wherein the application is changed from a first version to a second version to run in the application container image.

12. The computer readable medium of claim 11, further comprising instructions which, when stored in memory and executed by the one or more processors causes the one or more processors to perform acts of:
analyzing the application to determine an application profile attribute,
matching the application profile attribute to a candidate application container, and
determining, from the application profile attribute, one or more application components.

13. The computer readable medium of claim 12, wherein the one or more application components comprise at least one of, an application library, or an application configuration, or a virtual disk.

14. The computer readable medium of claim 13, wherein analyzing the application further comprises instructions which, when stored in memory and executed by the one or more processors causes the one or more processors to perform acts of matching a disk content from the virtual disk to an application profile.

15. The computer readable medium of claim 14, wherein the application profile is characterized by at least one of, an application name, an application version scope, or one or more application binary identifiers, or one or more application data identifiers, or one or more application configuration identifiers, or one or more application port signatures, or one or more application processes, or one or more application files, or any combinations therefrom.

16. The computer readable medium of claim 14, wherein the matching is performed using, an operating system migration directive, or a version upgrade directive, or an upgrade path, or a container image identifier, or a package information attribute, or a user constraint or any combinations therefrom.

17. The computer readable medium of claim 11, further comprising instructions which, when stored in memory and executed by the one or more processors causes the one or more processors to perform acts of migrating the application container image from the application container to a target virtual machine.

18. The computer readable medium of claim 11, wherein a guest operating system corresponding to the virtual machine is different from a host operating system corresponding to the application container image.

19. A system comprising:
a storage medium having stored thereon a sequence of instructions; and
one or more processors that execute the instructions to cause the one or more processors to perform a set of acts, the acts comprising:
identifying a computing system comprising a virtual machine that executes an application;
identifying the application to be migrated to an application container;
selecting an application container image corresponding to the application from the virtual machine; and
invoking the application container image to run in the computing system in place of the application in the virtual machine, wherein the application is changed from a first version to a second version to run in the application container image.

20. The system of claim 19, further comprising instructions which, when stored in memory and executed by one or more processors causes the one or more processors to perform a set of acts, the set of acts comprising migrating the application container image from the application container to a target virtual machine.
